(19) United States
(12) Patent Application Publication
(10) Pub. No.: US 2003/0046492 A1
(43) Pub. Date: Mar. 6, 2003

(54) Configurable memory array

(75) Inventors: Michael K. Gschwind, Yorktown, NY (US); Valentina Salapura, Yorktown, NY (US)

Correspondence Address: Frank Chau, F. CHAU & ASSOCIATES, LLP, Suite 501, 1900 Hempstead Turnpike, East Meadow, NY, 11554, US

(73) Assignee: International Business Machines Corporation, Armonk, New York

(21) Appl. No.: 09/940,709

(22) Filed: Aug. 28, 2001

(51) Int. Cl. G06F 13/00

(52) U.S. Cl. 711/118; 711/170

(57) ABSTRACT

There is provided a memory system on a chip. The memory system includes a configurable memory having a first mode of operation wherein the configurable memory is configured as a cache and a second mode of operation wherein the configurable memory is configured as a local, non-cache memory. A selection of any of the first mode of operation and the second mode of operation is capable of being overridden by an other selection of an other of the first mode of operation and the second mode of operation. The configurable memory may be configured at manufacture time, at burn-in time, and/or during program execution. Moreover, an access mode of the configurable memory may be determined from an address corresponding to a memory access instruction.

### BACKGROUND OF THE INVENTION

1. Technical Field

The present invention relates generally to memory subsystems in computer systems and, in particular, to configurable memory arrays in computer systems.

2. Description of Related Art

Contemporary microprocessors are increasing in complexity and hence design costs. Furthermore, recent microprocessor technologies require tremendous investment to start up and to maintain the production of corresponding parts. As a result, the reuse of microprocessors in multiple application domains, such as embedded systems, set-top boxes, game consoles, network computers, desktop systems, engineering workstations, and servers, is paramount to achieve economies of scale which justify continued investment in the development and production of new parts.

One major differentiating factor for computer system use is the available memory subsystem, that is, the collection of cache hierarchies and main memory used to provide data to the microprocessor. While many applications of microprocessors are extremely cost sensitive and do not require large memories (such as embedded systems and set-top boxes), workstations and in particular servers require robust memory subsystems which can cope with significant bandwidth requirements and large working sets without degrading performance.

Thus, reuse requirements and application requirements may pose diametrically opposed requirements on the design of a computer system. For example, embedded-type applications require low part count and low price but can accept limitations in the size of accessible memory, while servers are less cost sensitive but require massive and robust memory subsystems.

Today, many microprocessor vendors use separate chip implementations of a common architecture for different application areas. While this allows synergy at the architecture level, each implementation can be optimized for the particular application area. However, as processor design cost increases, this approach is often no longer feasible.

One strategy uses the same microprocessor chips, but surrounds them with different memory subsystems to accommodate the difference in memory usage characteristics of different application areas. However, this approach requires differentiation to occur at the chip (or package) boundary with the system, which usually has only a limited amount of bandwidth. To provide differentiation potential in hierarchy levels which offer higher bandwidth requires the differentiation to occur on the chip or within the package in which the microprocessor and additional support logic are contained.

To date, microprocessor implementation reuse options have included either the provision of “soft macro” or “hard macro” cells which could be used to instantiate different chips based on the same microprocessor core architecture for various system configurations. This design strategy is frequently used for modular, application specific designs, usually including a standardized on-chip bus-interface (such as the IBM CoreConnect™ bus). While this design strategy reduces chip design cost significantly, each design must still be manufactured separately and little volume synergy is achieved at the production level.

Accordingly, it would be desirable and highly advantageous to have a memory subsystem that has different memory configuration options that are suitable for a wide range of applications with widely differing cost and performance constraints. Moreover, it would be desirable and highly advantageous to provide a high bandwidth to the memory subsystem while allowing for the reuse of parts at the packaged chip level to achieve economies of scale.

### SUMMARY OF THE INVENTION

The problems stated above, as well as other related problems of the prior art, are solved by the present invention, a configurable memory array.

Advantageously, the configurable memory array has different memory configuration options that are suitable for a wide range of applications with widely differing cost and performance constraints. For example, the configurable memory array can be used in microprocessor implementations as either a local memory which is not backed by any further external memory hierarchy, or as a level of cache hierarchy which is further backed by another level of memory hierarchy. The configurable memory array is capable of providing a high bandwidth while allowing for the reuse of parts at the packaged chip level to achieve economies of scale.

According to an aspect of the present invention, there is provided a memory system on a chip. The memory system comprises a configurable memory having a first mode of operation wherein the configurable memory is configured as a cache and a second mode of operation wherein the configurable memory is configured as a local, non-cache memory. A selection of any of the first mode of operation and the second mode of operation is capable of being overridden by an other selection of an other of the first mode of operation and the second mode of operation.

According to another aspect of the present invention, there is provided a memory system on a chip. The memory system comprises a configurable Random Access Memory (RAM) array having a first mode of operation wherein the configurable RAM array is configured as a local, non-cache memory and a second mode of operation wherein the configurable RAM array is configured as a cache. The configurable RAM array has a memory portion for storing tag bits and data bits in a single logical line in the second mode of operation.

According to yet another aspect of the present invention, there is provided a data storage system. The data storage system comprises at least one microprocessor, and a configurable memory, integrated with the at least one processor, for servicing the at least one microprocessor in a first mode of operation that emulates a local, non-cache memory and a second mode of operation that emulates a cache. A selection of any of the first mode of operation and the second mode of operation is capable of being overridden by another selection of an other of the first mode of operation and the second mode of operation.

According to still another aspect of the present invention, there is provided a memory system on a chip. The memory system comprises a processor, and a configurable memory having three modes of operation. A first mode of operation emulates a local, non-cache memory. A second mode of operation emulates a cache. A third mode of operation emulates both the local memory and the cache, wherein any of the three modes of operation may be selected at any given time.

According to a further aspect of the present invention, there is provided a method for accessing data. The method comprises the step of providing a configurable memory on a chip. Control logic is provided on the chip for selecting between a first mode of operation and a second mode of operation of the configurable memory and for overriding a previous selection of the first mode of operation or the second mode of operation. The configurable memory is configured as a local, non-cache memory in the first mode of operation, and as a cache in the second mode of operation. The data is accessed from the configurable memory, based upon a mode of the configurable memory.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating a packaged microprocessor including a memory subsystem according to an illustrative embodiment of the present invention;

FIG. 2 is a diagram illustrating the packaged microprocessor 100 of FIG. 1 (including the memory subsystem 130) in a low cost configuration targeted at set-top box applications, according to an illustrative embodiment of the present invention;

FIG. 3 is a diagram illustrating the packaged microprocessor 100 of FIG. 1 (including the memory subsystem 130) in a server configuration employing external main memory, according to an illustrative embodiment of the present invention;

FIG. 4 is a diagram illustrating the components and operation of a configurable memory array, according to an illustrative embodiment of the present invention;

FIG. 5 is a flow diagram illustrating exemplary access modes and exemplary configuration options for the configurable memory array 130, according to an illustrative embodiment of the present invention; and

FIG. 6 is a flow diagram illustrating a method for accessing data, according to an illustrative embodiment of the present invention.

### DETAILED DESCRIPTION OF PREFERRED EMBODIMENTS

It is to be understood that the present invention may be implemented in various forms of hardware, software, firmware, special purpose processors, or a combination thereof. Preferably, the present invention is implemented as a combination of both hardware and software, the software being an application program tangibly embodied on a program storage device. The application program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the application program (or a combination thereof) which is executed via the operating system. In addition, various other peripheral devices may be connected to the computer platform such as an additional data storage device.

It is to be further understood that, because some of the constituent system components depicted in the accompanying Figures may be implemented in software, the actual connections between the system components may differ depending upon the manner in which the present invention is programmed. Given the teachings herein, one of ordinary skill in the related art will be able to contemplate these and similar implementations or configurations of the present invention.

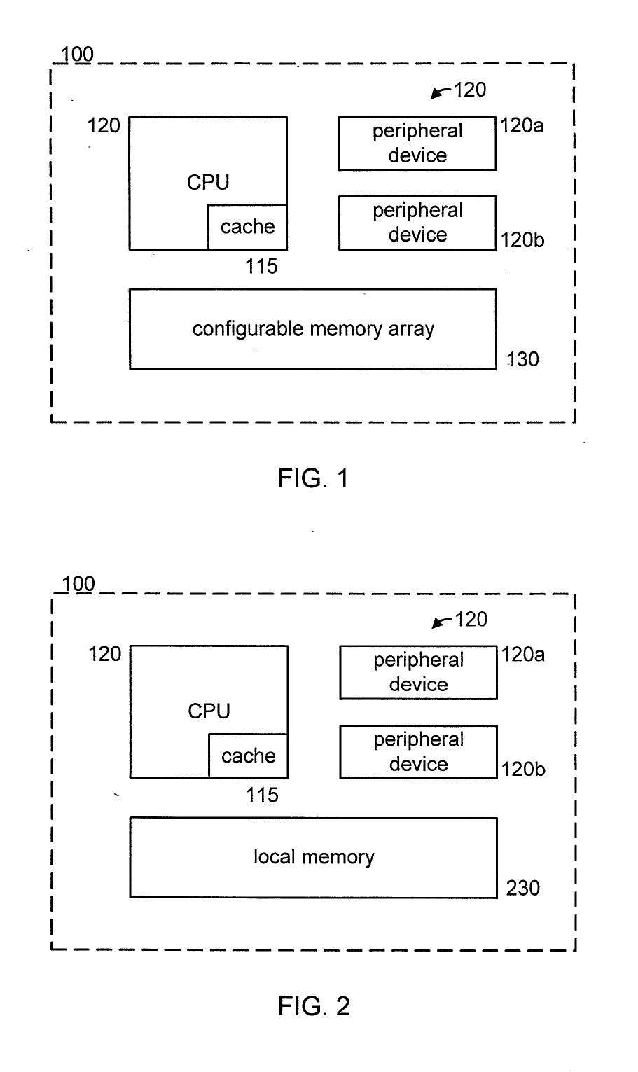

FIG. 1 is a diagram illustrating a packaged microprocessor 100 including a memory subsystem according to an illustrative embodiment of the present invention. The packaged microprocessor 100 includes a central processing unit (hereinafter “CPU”) 110 and one or more levels of tightly integrated cache (hereinafter “cache”) 115. Moreover, the packaged microprocessor 100 includes system peripheral 120 components such as device controllers 120a and/or network interfaces 120b (hereinafter collectively referred to as system peripheral(s) 120), and the configurable memory array 130. It is to be appreciated that while the packaged microprocessor 100 is described herein to include the system peripheral components 120, such elements are optional and, thus, may be omitted and/or replaced in other implementations of a packaged microprocessor according to the present invention. That is, given the teachings of the present invention provided herein, one of ordinary skill in the related art will contemplate these and various other configurations of the elements of the packaged microprocessor 100, such other configurations being within the scope and spirit of the present invention.

The packaged microprocessor 100 can be produced as either a system on a chip or a system in a package; moreover, other manufacturing approaches may be employed therefor. The basic packaged microprocessor 100 is intended to be personalized for a variety of application including, but not limited to, those described herein below. It is to be appreciated that the configuration of the configurable memory array 130 can be performed at any point in the manufacturing cycle or during actual use. Moreover, the configurable memory array 130 can be configured using a variety of approaches, apparatus, a combination thereof, and/or other means. For example, the configuration of the configurable memory array 130 can be: performed one-time (e.g., using a fuse); determined by system configuration (e.g., a pin in the package); performed at boot time; and/or software controlled by either application or privileged software.

FIG. 2 is a diagram illustrating the packaged microprocessor 100 of FIG. 1 (including the memory subsystem 130) in a low cost configuration targeted at set-top box applications, according to an illustrative embodiment of the present invention. That is, the configurable memory array 130 of FIG. 1 has been configured as a local memory LM 230 that serves as main memory. The packaged microprocessor 100 may be used to provide a full computer system or be integrated with additional peripheral components.

In this configuration, the configurable memory array 130 serves as the main memory wherein application program code and data are stored. A computer system based on this configuration does not require but may include external memory. In the latter case, the local memory LM 230 (implemented by the configurable memory array 130) and the external memory 305 may share address space. That is, the particular address determines whether an item is stored within the packaged microprocessor 100, or the external memory 305 accessible via the external bus 310.

A computer system based on this configuration operates as described immediately hereinafter. The CPU 110 executes microprocessor instructions in accordance with a microprocessor architecture, such as, for example, IBM PowerPC™. The instructions can be provided by a read-only memory which may be included as a “System On a Chip” (SOC) component 120, the local memory LM 230 (implemented by the configurable memory array 130), or an external memory source. The external memory source may be, for example, an external random access memory (RAM) or a read-only memory (ROM) accessible via an external bus.

The CPU 110 performs data memory access operations in response to memory access instructions (such as “load” and “store” instructions). In accordance with this configuration, memory operations are usually, but not exclusively, directed at read-accessing or write-accessing the data contained in the local memory 230.

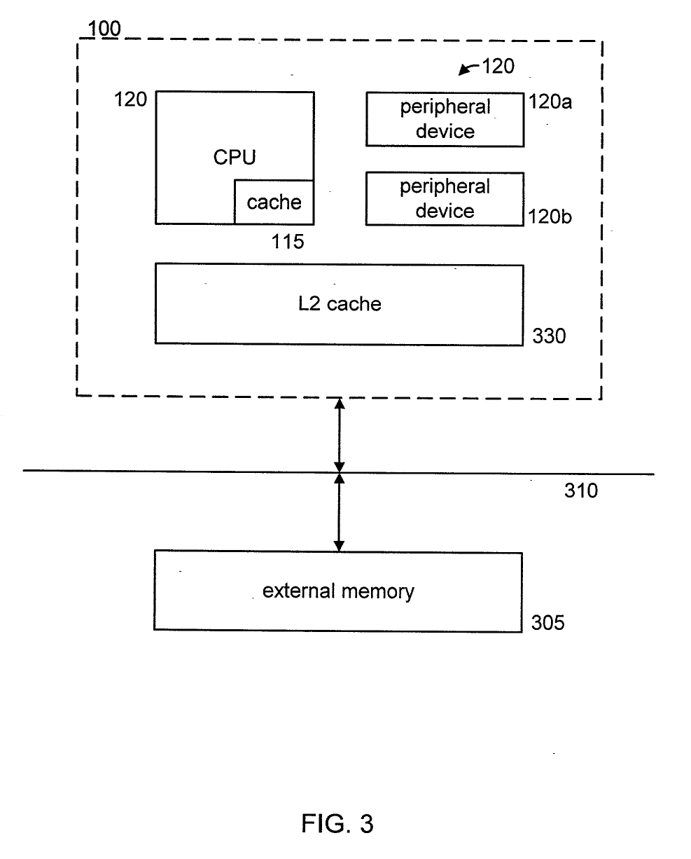

FIG. 3 is a diagram illustrating the packaged microprocessor 100 of FIG. 1 (including the memory subsystem 130) in a server configuration employing external main memory, according to an illustrative embodiment of the present invention. The configurable memory array 130 has been configured as a unified second level memory L2 330 (hereinafter “L2 cache”). In this role, the configurable memory array 130 can be organized, for example, as an instruction cache, a data cache, or a unified cache. The packaged microprocessor 100 is connected to an external bus or point-to-point link (hereinafter “external bus”) 310 which interfaces to external memory which serves as main memory.

When operating in this configuration, the memory accesses from the CPU 110 go to the local level one cache (hereinafter “L1 cache”) 115. If a cache miss occurs in the L1 cache 115, then the memory request is sent to the L2 cache 330, where the request may or may not be satisfied. If a cache miss occurs at the L2 cache 330, then the memory request is sent to the external memory 305 via the external bus 310. The external memory 305 serves as a system main memory, and contains application program code and data.

A system based on this configuration operates as described immediately hereinafter. The CPU executes microprocessor instructions in accordance with a microprocessor architecture, such as, for example, IBM PowerPC™. The instructions are accessed from the L1 cache 115. In the case of a cache miss in the L1 cache 115, the L2 cache 330 is accessed. If data is contained in the L2 cache 330, then the data is transferred as a result of the request. If a miss occurs in the L2 cache 330, then an access is performed to the next lower memory hierarchy level, e.g., an external main memory.

The CPU 110 performs data memory access operations in response to memory access instructions (such as “load” and “store” instructions). In accordance with this configuration, memory operations usually, but not exclusively, first access the first level data cache (hereinafter “L1 data cache”) 115. In the case of a cache miss in the L1 data cache 115, the L2 cache 330 is accessed. If data is contained in the L2 cache 330, then the data is transferred as a result of the request. If a miss occurs in the L2 cache 330, then an access is performed to the next lower memory hierarchy level, e.g., an external main memory.

While this exemplary configuration has employed the configurable memory array 130 as a second level (L2) cache 330, one of ordinary skill in the related art will readily ascertain that the configurable memory array 130 can serve as a cache at any hierarchy level in a hierarchical memory configuration.

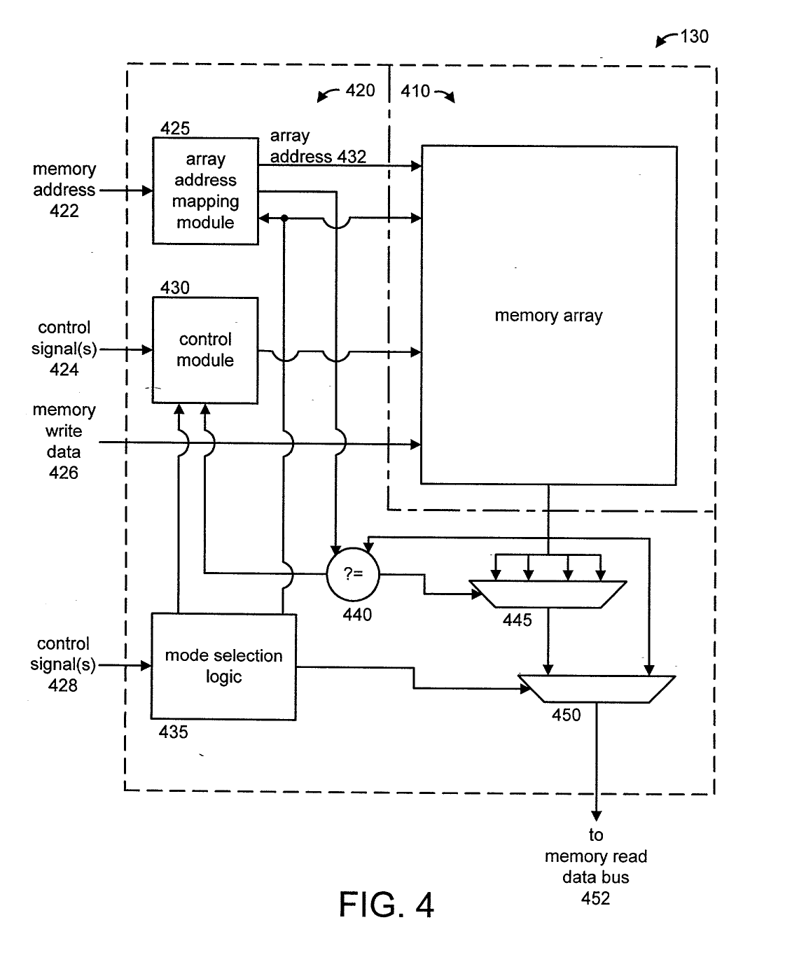

FIG. 4 is a diagram illustrating the components and operation of the configurable memory array 130, according to an illustrative embodiment of the present invention. The configurable memory array 130 includes a memory array 410 and memory configuration logic 420. It is to be appreciated that the description of the components and operation of the configurable memory array 130 of FIG. 4 is also applicable to the local memory 230 of FIG. 2 and the L2 cache 330 of FIG. 3.

The memory configuration logic 420 provides the interface to the memory array 410. The memory configuration logic 420 is responsible for processing address information before the address information is passed to the memory array 410, and processing the data being read or written to the memory array 410. The memory configuration logic 420 is further responsible for selecting the operating mode of the configurable memory array 130. Such selection of the operating mode may be based on, for example, the memory address, mode information received in conjunction with the memory address, a configuration register, a configuration signal, and/or other control information. That is, given the teachings of the present invention provided herein, one of ordinary skill in the related art will contemplate these and various other criteria upon which selection of the operating mode of the configurable memory array 130 can be based, while maintaining the spirit and scope of the present invention.

The memory configuration logic 420 includes an array address mapping module 425, a control module 430, mode selection logic 435, tag match logic 440, and multiplexers 445 and 450. The configuration of the memory array 410 is controlled by the mode selection logic 435, which generates all necessary control and configuration signals. The mode of operation can be selected by: control signals 428, which can, for example, be generated on the package (e.g., with programmable fuses), from the input pins or hardwired; from a configuration register, which may be configured either by at system boot time or by software through the use of a predefined interface; or be determined by control signals transmitted in conjunction with the memory address, or may be a function the memory address itself. These control logic components enable, for example, four modes of operation: local memory read mode; local memory write mode; cache read mode; and cache write mode.

A description will now be given of the local memory read mode of operation of the configurable memory array 130. When the local memory configuration is selected by mode selection logic 435, a read operation is performed as follows: the memory address 422 and one or several control signals 424 are input to the configurable memory array 130. The array address mapping module 425 maps the memory address 422 to an array address 432, and the control module 430 generates signals necessary to read data from the addressed memory location. Data read from the memory array 410 are passed to the memory read data bus 452 via the multiplexer 450 under the control of the mode selection logic 435.

A description will now be given of the local memory write mode of operation of the configurable memory array 130. When the local memory configuration is selected by mode selection logic 435, a write operation is performed as follows: the memory address 422, one or several control signals 424, and memory write data 426 are input to the configurable memory array 130. The array address mapping module 425 maps the memory address 422 to an array address 432, and the control module 430 generates signals necessary to write the memory write data 426 to the memory array 410 based upon the array address 432. One of ordinary skill in the related art will readily appreciate that partial line write operations can be performed using a variety of approaches, apparatus, a combination thereof, and/or other means, while maintaining the spirit and scope of the present invention. For example, partial line write operations can be performed using subline write-enable logic or read-modify-write logic.

A description will now be given of the cache read mode of operation of the configurable memory array 130. When the cache mode configuration is selected by mode selection logic 435, a read operation is performed as follows: the memory address 422 and one or several control signals 424 are input to the configurable memory array 130. The array address mapping module 425 maps the memory address 422 to an array address 432, and the control module 430 generates signals necessary to read data from the addressed memory location. Data read from the memory array 410 are compared for tag match in the tag match logic 440. If a cache hit occurs, then the addressed data are selected using the multiplexer 445, and the result is passed to the memory read data bus 452 by corresponding selection of the multiplexer 450. In the preferred embodiment, cache tags are included in data lines stored in the memory array 410, but alternative implementations can include separate memory arrays for storing data and tags.

A description will now be given of the cache write mode of operation of the configurable memory array 130. When the cache mode configuration is selected by the mode selection logic 435, a write operation is performed as follows: the memory address 422 and one or several control signals 424 are input to the configurable memory array 130. The array address mapping module 425 maps the memory address 422 to an array address 432, and the control module 430 generates signals necessary to read data from the memory location addressed by the array address 432. Data read from the memory array 410 are compared for tag match in the block 440. If a cache hit occurs, then the control module 430 generates signals necessary to write the memory write data 426 to the array address 432 to the corresponding cache set and line. One of ordinary skill in the related art will readily appreciate that partial line write operations can be performed using a variety of approaches, apparatus, a combination thereof, and/or other means, while maintaining the spirit and scope of the present invention. For example, partial line write operations can be performed using subline write-enable logic or read-modify-write logic.

If a cache miss occurs, then multiple policies are possible, including but not limited to the following described immediately hereinafter.

One policy that may be employed in the case of a cache miss is a “write allocate”. In such a case, the cache miss is processed, and the corresponding line is fetched to the cache from the next lower level of the memory hierarchy. Subsequently, the store processing resumes and the store is performed in the configurable memory array 130, in the same manner as described above for the cache hit.

Another policy that may be employed in the case of a cache miss is a “write around”. In such a case, data are sent to write to the next lower level of the memory hierarchy without loading the data to the cache. In this embodiment, the memory write data 426 are sent to the external memory 305 via the external bus 310 without modifying the contents of the memory array 410.

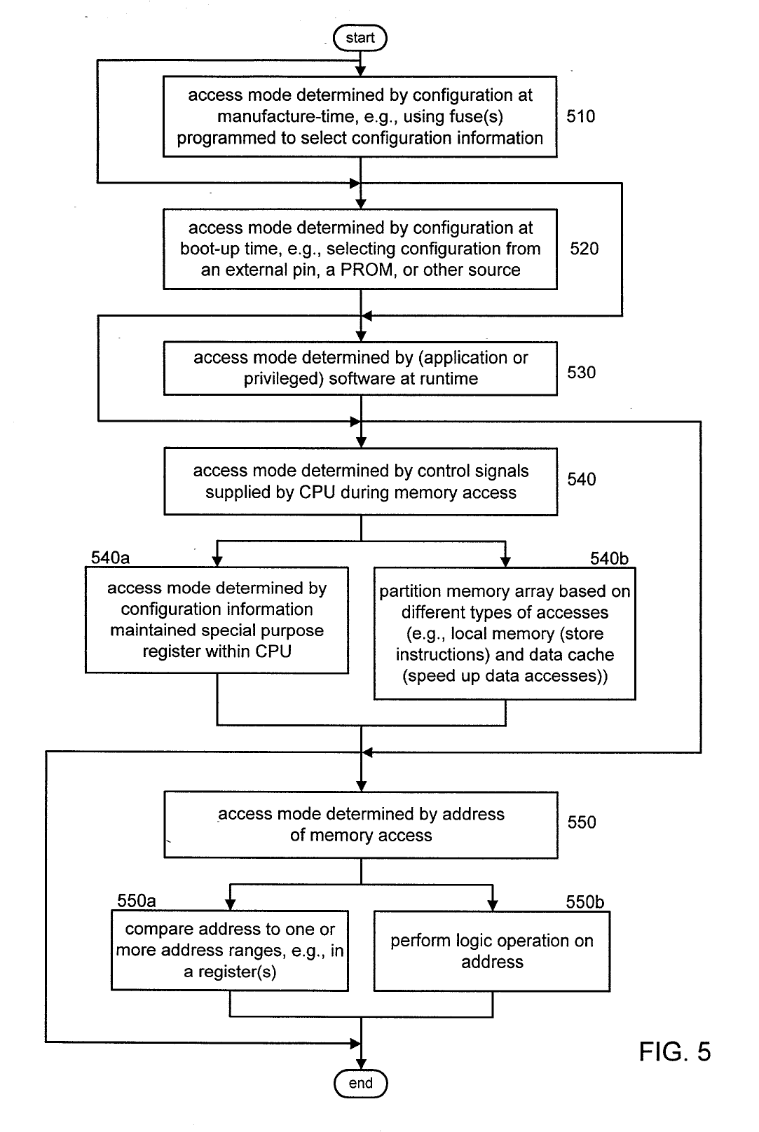

Exemplary access modes and exemplary configuration options for a configurable memory according to the present invention include but are not limited to the following described immediately hereinafter with respect to FIG. 5. FIG. 5 is a flow diagram illustrating exemplary access modes and exemplary configuration options for the configurable memory array 130, according to an illustrative embodiment of the present invention. It is to be appreciated that each of the configuration options shown in FIG. 5 may be employed individually (without using any other configuration options) or in combination(s). For example, some of the configuration options described with respect to FIG. 5 occur at boot time and others during a memory access. Thus, a boot time configuration can be used to initially configure the configurable memory array of the present invention, with a subsequent configuration(s) used to modify the initial configuration. Given the teachings of the present invention provided herein, one of ordinary skill in the related art will contemplate these and various other configuration options and implementation times therefor as well as corresponding access modes, all while maintaining the spirit and scope of the present invention.

One exemplary configuration option is as follows. When the system is configured at manufacture time, the configurable memory array 130 is also configured (step 510). This configuration may be used to specify the access mode(s) employed by the configurable memory array. The configurable memory array may be configured at such time using, for example, one or more fuses programmed to select the configuration information. As an example, the configuration information may be selected to reflect the use of the packaged microprocessor 100 in an embedded system or a server system. Of course, other intended uses may also be reflected in the configuration information.

Another exemplary configuration option is as follows. When the system is booted, the configuration of the configurable memory array 130 is selected (step 520). This configuration may be used to specify the access mode(s) employed by the configurable memory array. The configuration may be selected, for example, from an external pin, or a programmable read-only memory (“PROM”), or other source to reflect the use of the packaged microprocessor 100 in an embedded system or a server system.

A further exemplary configuration option is as follows. During runtime, the configuration of the configurable memory array 130 is selected based upon software (step 530). This configuration may be used to specify/change the access mode(s) employed by the configurable memory array. As an example, software (e.g., application and/or privileged software) changes a control register controlling the configuration of the configurable memory array 130 at runtime to select or modify the configuration of the configurable memory array 130 in accordance with desired system properties.

Still yet another exemplary configuration option is as follows. When the CPU 110 performs a memory access, the access mode of the configurable memory array 130 is selected based upon additional control signals supplied (step 540). For example, when the CPU 110 performs a memory access, additional control signals supplied by the CPU 110 determine whether the memory array is to be treated as local memory or cache. This might be used to control the configuration based on a special purpose register maintained within the microprocessor (step 540a), or to partition the memory array based on different types of accesses (step 540b), e.g., using different memory access instructions for configurable memory array partitions implementing a local memory and data cache, or using a local memory to store instructions, and a caching partition to speed up data memory accesses.

Yet another exemplary configuration option is as follows. When the CPU 110 performs a memory access, the access mode of the configurable memory array 130 is selected based upon the address of the memory access (step 550). For example, when the CPU 110 performs a memory access, the supplied address of the access determines whether the memory array is to be treated as local memory or cache. This can be used to effectively partition the configurable memory array 130 into (1) a small high-speed local working memory for data processing and (2) a cache for access to a large system memory. The control information may be obtained by comparing the address to one or more address ranges contained in configuration register(s) (step 550a), or by performing any of a variety of logical operations on the address bits (step 550b).

While the invention has taught the capabilities of the configurable memory array 130 in basic configurations, it will be readily apparent to one of ordinary skill in the related art, given the teachings herein, that a configurable memory array can be employed in various other configurations and using various other access modes. For example, a configurable memory array according to the present invention may be employed as local memory and/or one or multiple levels of caches, in any number and type of peripheral devices contained either on a common chip, a common package, in a multi-chip solution. The configurable memory array can be included on a chip with other components, or may be implemented as a separate chip either to be included in a common package with other chips, or packaged individually. Given the teachings of the present invention provided herein, one of ordinary skill in the related art will readily contemplate these and various other configurations and implementations of a configurable memory array, while maintaining the spirit and scope of the present invention.

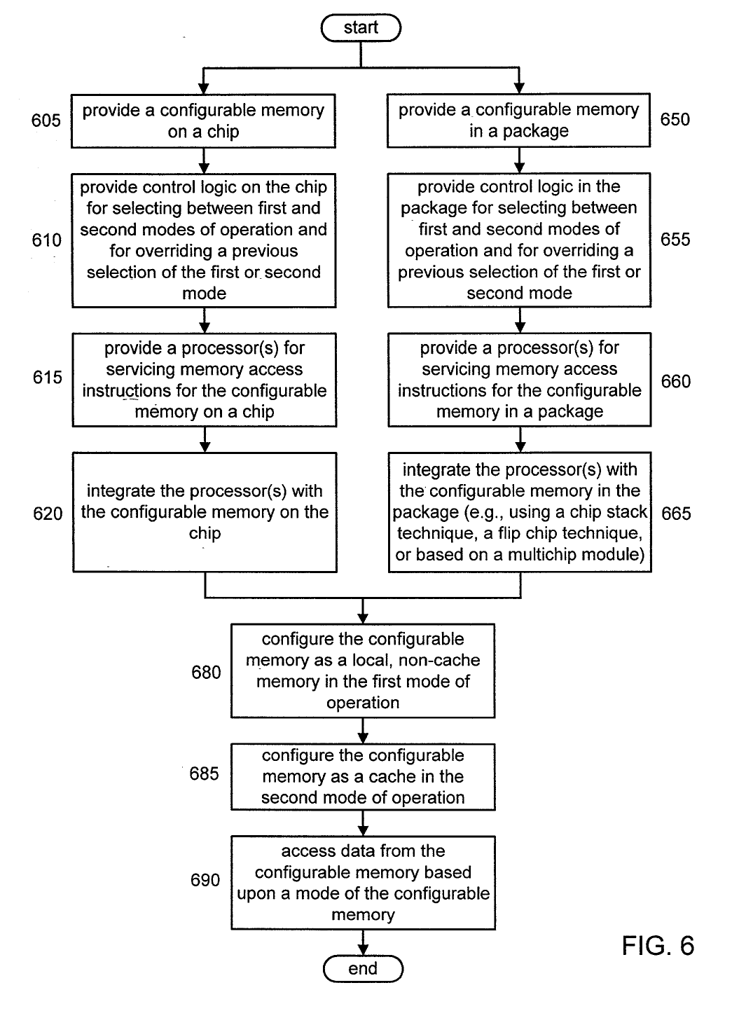

FIG. 6 is a flow diagram illustrating a method for accessing data, according to an illustrative embodiment of the present invention. A configurable memory on a chip is provided (step 605). Alternatively, a configurable memory in package may be provided (step 650).

If the configurable memory on the chip is provided (per step 605), then control logic is provided on the chip for selecting between a first mode of operation and a second mode of operation and for overriding a previous selection of the first mode of operation or the second mode of operation (step 610). Further, at least one processor is provided for servicing memory access instructions for the configurable memory on the chip (step 615), and the at least one processor is integrated with the configurable memory on the chip (step 620).

If the configurable memory in the package is provided (per step 650), then control logic is provided in the package for selecting between a first mode of operation and a second mode of operation and for overriding a previous selection of the first mode of operation or the second mode of operation (step 655). Further, at least one processor is provided for servicing memory access instructions for the configurable memory in the package (step 660), and the at least one processor is integrated with the configurable memory in the package (step 665). Such integration may be implemented, e.g., using a chip stack technique, a flip chip technique, or may be based on a multichip module.

Then, irrespective of whether the configurable memory was provided on a chip (per step 605) or in a package (per step 650), the configurable memory is configured as a local, non-cache memory in the first mode of operation (step 680), and is configured as a cache in the second mode of operation (step 685). Data is accessed from the configurable memory, based upon a mode of the configurable memory (step 690). Various illustrative embodiment of data access are described above with respect to FIG. 5.

Although the illustrative embodiments have been described herein with reference to the accompanying drawings, it is to be understood that the present system and method is not limited to those precise embodiments, and that various other changes and modifications may be affected therein by one skilled in the art without departing from the scope or spirit of the invention. All such changes and modifications are intended to be included within the scope of the invention as defined by the appended claims.

What is claimed is:

1. A memory system on a chip, comprising:
a configurable memory having a first mode of operation wherein the configurable memory is configured as a cache and a second mode of operation wherein the configurable memory is configured as a local, non-cache memory, and
wherein a selection of any of the first mode of operation and the second mode of operation is capable of being overridden by an other selection of an other of the first mode of operation and the second mode of operation.

2. The memory system of claim 1, wherein the configurable memory is capable of having either the first mode of operation or the second mode of operation selected at a burn-in time.

3. The memory system of claim 2, wherein the first mode of operation or the second mode of operation is selected at the burn-in time using a fuse.

4. The memory system of claim 1, wherein the configurable memory is capable of having either the first mode of operation or the second mode of operation selected at a power-up time.

5. The memory system of claim 4, wherein the first mode of operation or the second mode of operation is selected at the power-up time using an external signal.

6. The memory system of claim 1, wherein the configurable memory is capable of having either the first mode of operation or the second mode of operation selected during a program execution.

7. The memory system of claim 6, wherein the first mode of operation or the second mode of operation is selected during the program execution based upon a value of a special configuration register.

8. The memory system of claim 6, wherein the first mode of operation or the second mode of operation is selected during the program execution based upon a value of an external signal.

9. The memory system of claim 6, wherein the first mode of operation or the second mode of operation is selected during the program execution based upon a supplied address.

10. The memory system of claim 1, wherein the configurable memory is capable of having either the first mode of operation or the second mode of operation selected based upon a result of comparing a supplied address to a range of addresses.

11. The memory system of claim 10, wherein the range of addresses are determined at a burn-in time.

12. The memory system of claim 10, wherein the range of addresses are determined at a boot-up time.

13. The memory system of claim 10, wherein the range of addresses are determined dynamically.

14. The memory system of claim 10, further comprising a configuration register for storing the range of addresses.

15. The memory system of claim 1, wherein the configurable memory comprises:
a memory array; and
memory configuration logic for selecting the first mode of operation or the second mode of operation.

16. The memory system of claim 1, wherein the configurable memory is capable of selecting one of a local memory read mode and a local memory write mode in the first mode of operation and is further capable of selecting one of a cache read mode and a cache write mode in the second mode of operation.

17. The memory system of claim 1, wherein the selection may be overridden by the other selection dynamically.

18. The memory system of claim 1, wherein the configurable memory comprises a plurality of static random access memory cells.

19. The memory system of claim 1, wherein the configurable memory comprises a plurality of dynamic random access memory cells.

20. The memory system of claim 1, wherein the configurable memory is capable of being dynamically employed as a sole memory serving the processor and as a portion of a larger, memory hierarchy.

21. The memory system of claim 1, wherein the first mode of operation and the second mode of operation are employed concurrently.

22. A memory system on a chip, comprising:
a configurable Random Access Memory (RAM) array having a first mode of operation wherein the configurable RAM array is configured as a local, non-cache memory and a second mode of operation wherein the configurable RAM array is configured as a cache, and
wherein the configurable RAM array has a memory portion for storing tag bits and data bits in a single logical line in the second mode of operation.

23. The memory system of claim 22, further comprising control logic for selectively providing direct access to the configurable RAM array as the local, non-cache memory in the first mode of operation and as the cache in the second mode of operation.

24. The memory system of claim 22, wherein the single logical line spans several physical macro cells.

25. The memory system of claim 22, further comprising:
tag match logic for determining a match between the stored tag bits and bits corresponding to a memory access; and
at least one multiplexer for selecting and outputting data corresponding to the memory access, when the match is determined.

26. A data storage system, comprising:
at least one microprocessor; and
a configurable memory, integrated with the at least one processor, for servicing the at least one microprocessor in a first mode of operation that emulates a local, non-cache memory and a second mode of operation that emulates a cache,
wherein a selection of any of the first mode of operation and the second mode of operation is capable of being overridden by another selection of an other of the first mode of operation and the second mode of operation.

27. The data system of claim 26, wherein the at least one microprocessor and the configurable memory array are integrated on a single chip.

28. The data system of claim 26, wherein the at least one microprocessor and the configurable memory array are integrated in a single package.

29. A memory system on a chip, comprising:
a processor; and
a configurable memory having three modes of operation, a first mode of operation for emulating a local, non-cache memory, a second mode of operation for emulating a cache, and a third mode of operation for emulating both the local memory and the cache, wherein any of the three modes of operation may be selected at any given time.

30. A method for accessing data, comprising the steps of:
providing a configurable memory on a chip;
providing control logic on the chip for selecting between a first mode of operation and a second mode of operation of the configurable memory and for overriding a previous selection of the first mode of operation or the second mode of operation;
configuring the configurable memory as a local, non-cache memory in the first mode of operation;
configuring the configurable memory as a cache in the second mode of operation; and
accessing the data from the configurable memory, based upon a mode of the configurable memory.

31. The method of claim 30, further comprising the steps of:
providing at least one microprocessor for servicing memory access instructions for the configurable memory; and
integrating the at least one microprocessor with the configurable memory on the chip.

32. The method of claim 30, wherein the chip comprises a single chip.

33. A method for accessing data, comprising the steps of:
providing a configurable memory in a package;
providing control logic in the package for selecting between a first mode of operation and a second mode of operation of the configurable memory and for overriding a previous selection of the first mode of operation or the second mode of operation;
configuring the configurable memory as a local, non-cache memory in the first mode of operation;
configuring the configurable memory as a cache in the second mode of operation; and
accessing the data from the configurable memory, based upon a mode of the configurable memory.

34. The method of claim 33, further comprising the steps of:
providing at least one microprocessor for servicing memory access instructions for the configurable memory; and
integrating the at least one microprocessor with the configurable memory in the package.

35. The method of claim 341 wherein said integrating step integrates the at least one microprocessor with the configurable memory based upon a chip stack technique.

36. The method of claim 34, wherein said integrating step integrates the at least one microprocessor with the configurable memory based upon a flip chip technique.

37. The method of claim 34, wherein said integrating step integrates the at least one microprocessor with the configurable memory based upon a multi-chip module.
